(19) United States
(12) Patent Application Publication
(10) Pub. No.: US 2024/0158982 A1
(43) Pub. Date: May 16, 2024

(54) A PRODUCTION SYSTEM

(71) Applicant: TUSAS- TURK HAVACILIK VE UZAY SANAYII ANONIM SIRKETI, Ankara (TR)

(72) Inventor: Yahya OZ, Ankara (TR)

(21) Appl. No.: 18/281,881

(22) PCT Filed: Mar. 22, 2022
(86) PCT No.: PCT/TR2022/050256

§ 371 Date: Sep. 13, 2023

(30) Foreign Application Priority Data
Mar. 24, 2021 (TR) 2021/005305

(51) Int. Cl. D06M 11/83; D06M 10/06; D06M 11/74; D06M 23/06; D06M 23/08

(52) U.S. Cl. CPC D06M 11/83; D06M 10/06; D06M 11/74; D06M 23/06; D06M 23/08; D06M 2200/00

(57) ABSTRACT

The present invention relates to at least one fiber (2) used in composite materials; a solution (C) containing a transition metal; at least one barrier coating unit (3) which enables the fiber (2) to be surrounded with the solution (C) by using a dip and/or spray coating method, thereby protecting the fiber (2) surface from chemical and/or physical impacts; at least one deposition unit (4) which enables graphene and/or graphene-based nanoribbons to be bonded with transition metals located at certain distances on the fiber (2) by using the chemical vapor deposition method, thus allowing the graphene and/or graphene-based nanoribbons to adhere to the fiber (2); and at least one iron coating unit (5) which enables application of iron-based nanoparticles on the fiber (2) using the dip and/or spray coating method.

The present invention relates to a production system for producing fibers with radar absorbing features by oriented nanomaterials.

Radar is a technique used for detecting and tracking an aircraft. It ensures that electromagnetic waves are transmitted to the atmosphere and reflected back from the aircraft to the receiving antenna. An image of an aircraft on a radar screen is called “radar cross section”. A larger radar cross section allows an object to be detected easily. The primary way to make aircraft invisible is to prevent the radio waves sent by radar transmitters from returning to the receiving antenna by bouncing off the target. Radar absorbing materials are designed to absorb radio frequency radiation (non-ionizing radiation), which is electromagnetic radiation, as effectively as possible. The working principle of radar absorbing materials is based on impedance matching or attenuation of the electromagnetic wave coming into the material by utilizing the properties of magnetic and dielectric materials.

The United States patent document US20170240425, which is included in the known state of the art, discloses a surface treatment method for synthesizing carbon nanotubes (CNT) on a fiber material. It discloses the application of barrier coating and transition metals on the fiber and the growth of carbon nanotubes (CNT) on transition metals.

Turkish patent document TR2020/09516, which is included in the known state of the art, discloses a radar absorbing structure based on oriented nanomaterials. The structure consists of a multi-layered nanocomposite. The barrier coating, which increases the strength of the fiber, comprises graphene-based nanoribbons with electrical conductivity on the barrier coating. In addition, the radar absorbing properties are increased with the iron-based nanoparticles (iron-based nanoparticle) therein.

Thanks to a production system according to the present invention, the length and/or density of graphene-based nanoribbons applied on the fiber by a chemical vapor deposition method can be controlled. Therefore, an effective material characterization is achieved.

Another object of the invention is to produce fibers with radar absorbing features by oriented nanomaterials in aviation standards. With fibers that have radar absorbing features real-scale mass production of air vehicles is provided.

A production system realized to achieve the object of the invention and defined in the first claim and the other claims dependent thereon comprises at least one fiber used in composite materials; a solution containing a transition metal; at least one barrier coating unit which allows the fiber to be coated with the solution by using a dip and/or spray coating method, thereby protecting the fiber surface from chemical and/or physical impacts; at least one deposition unit which enables graphene and/or graphene-based nanoribbons to be bonded with transition metals located at certain distances on the fiber by using the chemical vapor deposition (CVD) method, thus allowing the graphene and/or graphene-based nanoribbons to adhere to the fiber; and at least one iron coating unit which enables application of iron-based nanoparticles on the fiber using the dip and/or spray coating method.

The production system according to the invention comprises at least one movement element which enables the fiber to move along the direction it extends; a control unit which allows the fiber to be moved automatically by the movement element, thereby sequentially treating the fiber within the barrier coating unit, the deposition unit and the coating unit, wherein the control unit enables the determination of the time that the fiber will remain in the deposition unit according to the parameters predetermined by the user which affect the chemical vapor deposition process, thereby applying graphene and/or graphene-based nanoribbons of different densities and/or lengths on the fiber.

In an embodiment of the invention, the production system comprises a deposition unit having a chamber which allows the chemical vapor deposition method to be applied on the fiber, and at least one condenser located to almost completely surround the chamber, creating an electromagnetic field within the chamber, thus allowing the graphene and/or nanoribbons to be applied almost vertically on the fiber.

In an embodiment of the invention, the production system comprises a plurality of sensors located in the chamber, which send laser beams on the fiber; a control unit which enables real-time thickness measurement with the data received from the sensors, and ensures that the fiber is transmitted to the iron coating unit by means of the movement element when the thickness value predetermined by the user is achieved.

In an embodiment of the invention, the production system comprises a deposition unit having a plurality of openings which are provided on the chamber so as to have almost exactly the same diameter as the fiber, and enable the fiber to enter and exit the chamber and to apply the graphene and/or graphene-based nanoribbons almost evenly on the fiber, and at least one sealing element which prevents gaps between the fiber and the openings.

In an embodiment of the invention, the production system comprises a control unit which enables the fiber exiting the chamber by means of the openings to automatically re-enter the chamber by means of the movement element such that the fiber moves spirally around the chamber, thus allowing the application of graphene and/or graphene-based nanoribbon on the fiber simultaneously.

In an embodiment of the invention, the production system comprises at least one winding machine which provides automatic knitting of the fiber by means of the control unit; at least one fabric which enables the radio waves to be routed since the graphene and/or graphene-based nanoribbons on the fiber knitted by a winding machine create a conductive network.

In an embodiment of the invention, the production system comprises a control unit which enables:
to receive the fiber into the barrier coating unit and to apply a transition metal solution on the fiber,
to move the fiber by the movement element, so that the fiber enters automatically into the deposition unit,
to determine the time that the fiber will remain in the deposition unit according to the parameters predetermined by the user which affect the chemical vapor deposition process by the chemical vapor deposition method in the deposition unit, and to provide bonding of the graphene and/or graphene-based nanoribbons with transition metals, thereby adhering the graphene and/or graphene nanoribbons to the fiber,
to receive the fiber, on which graphene and/or graphene-based nanoribbon has been applied, automatically into the iron coating unit by means of the movement element,
to apply iron-based nanoparticles on the fiber in the iron coating unit,
to knit the fiber automatically by means of the winding machine.

In an embodiment of the invention, the production system comprises a first fabric made of glass fiber, which almost completely reduces the reflection of radio waves since it is an insulating material.

In an embodiment of the invention, the production system comprises a second fabric made of carbon fiber, which converts radio waves into heat and/or electrical energy so that they are almost completely absorbed.

In an embodiment of the invention, the production system comprises at least one radar absorbing structure formed by laying a number of first fabrics determined by the user on a number of second fabrics determined by the user, such that density and/or length of the graphene and/or graphene-based nanoribbon gradually decreases.

In an embodiment of the invention, the production system comprises a radar absorbing structure which can be used in air and/or space and/or marine vehicles.

In an embodiment of the invention, the production system comprises a sealing element in the form of an O-ring, a gasket and/or a paste.

In an embodiment of the invention, the production system comprises a movement element, which is a roller and/or a robotic arm.

The production system realized to achieve the object of the present invention is shown in the attached figures, wherein from these figures:

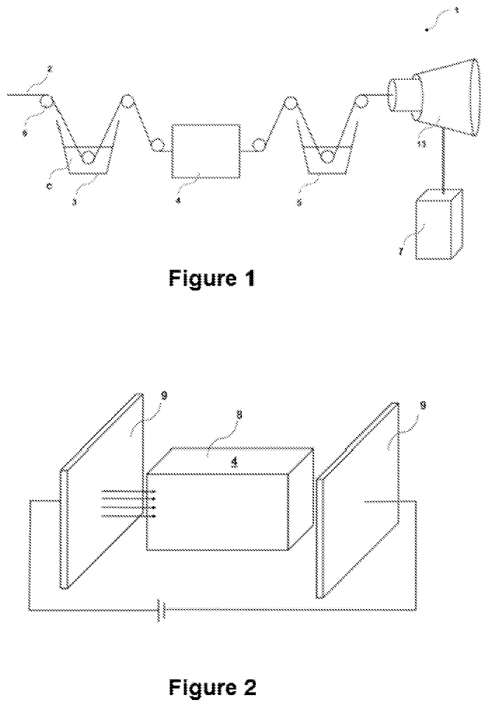

FIG. 1 is a schematic view of the production system.

FIG. 2 is a schematic view of the deposition unit and the condenser.

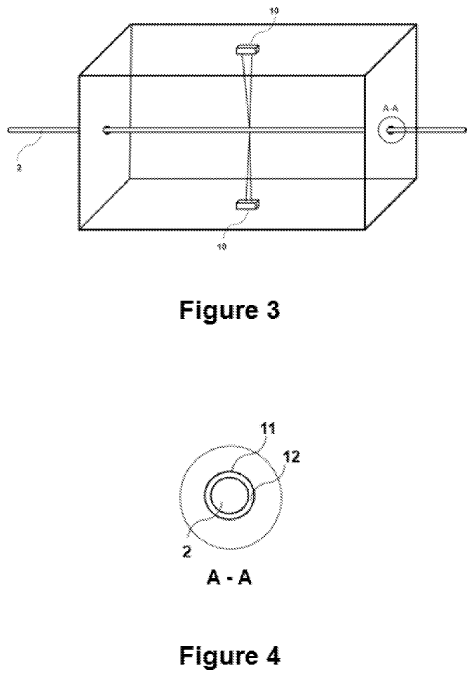

FIG. 3 is a schematic view of the deposition unit and the sensor.

FIG. 4 is a cross-sectional view of section A-A in FIG. 3.

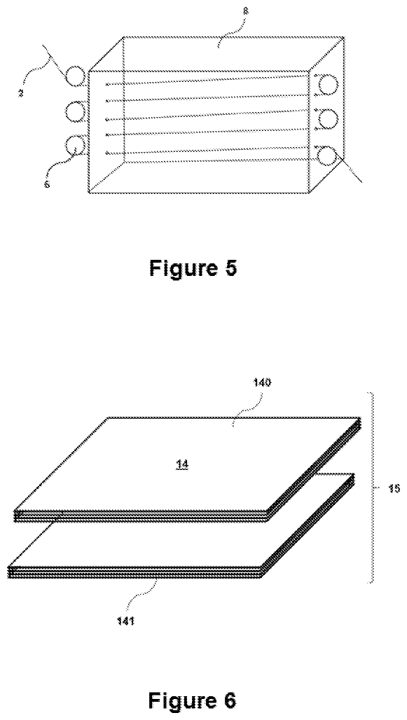

FIG. 5 is a schematic view of the deposition unit and the helical fiber.

FIG. 6 is a schematic view of the radar absorbing structure.

All the parts illustrated in figures are individually assigned a reference numeral and the corresponding terms of these numbers are listed below:
1. Production system
2. Fiber
3. Barrier coating unit
4. Deposition unit
5. Iron coating unit
6. Movement element
7. Control unit
8. Chamber
9. Condenser
10. Sensor
11. Opening
12. Sealing element
13. Winding machine
14. Fabric
140. First fabric
141. Second fabric
15. Radar absorbing structure
C. Solution

The production system (1) comprises at least one fiber (2) used in composite materials; a solution (C) containing a transition metal; at least one barrier coating unit (3) which enables the fiber (2) to be surrounded with the solution (C) by using a dip and/or spray coating method, thereby protecting the fiber (2) surface from chemical and/or physical impacts; at least one deposition unit (4) which enables graphene and/or graphene-based nanoribbons to be bonded with transition metals located at certain distances on the fiber (2) by using the chemical vapor deposition method, thus allowing the graphene and/or graphene-based nanoribbons to adhere to the fiber (2); and at least one iron coating unit (5) which enables application of iron-based nanoparticles on the fiber (2) using the dip and/or spray coating method (FIG. 1).

The production system (1) according to the invention comprises at least one movement element (6) which enables the fiber (2) to move along the direction it extends; a control unit (7) which allows the fiber (2) to be moved automatically by the movement element (6), thereby sequentially treating the fiber (2) within the barrier coating unit (3), the deposition unit (4) and the iron coating unit (5), wherein the control unit (7) enables the determination of the time that the fiber (2) will remain in the deposition unit (4) according to the temperature and/or pressure and/or time parameters determined by the user, thereby depositing graphene and/or graphene-based nanoribbons of different densities and/or lengths on the fiber (2) (FIG. 1).

The chemical vapor deposition method is applied by coating a solid material, which is formed as a result of the chemical reaction of a vaporous carrier gas, onto the heated material provided in a closed environment. Transition metals are applied on the fiber (2) prior to chemical vapor deposition for the controlled dispersion of graphene and/or graphene-based nanoribbons on the fiber (2). The transition metal used can be any element or alloy of elements included in the periodic table with d-orbitals. The barrier coating solution (C), which prevents rapid wear and damage to the fiber (2), is mixed with nano-sized transition metals, and the resulting mixture is applied on the fiber (2) using the dip and/or spray coating method. In the deposition unit (4), graphene and/or graphene-based nanoribbons are concentrated on transition metals by bonding with transition metals. Thus, graphene and/or graphene-based nanoribbons are deposited on the fiber (2) at certain distances. Iron-based nanoparticles are applied on the fiber (2) using the dip and/or spray coating method.

The control unit (7) ensures that the fiber (2) is automatically moved by the movement element (6) and is treated in the barrier coating unit (3), the deposition unit (4) and the iron coating unit (5) in an optimized and continuous manner. The temperature and/or pressure and/or time parameters, which are predetermined by the user and determine the time during which the fiber (2) is subjected to chemical vapor deposition, are input into the control unit (7) by the user. In this way, graphene and/or graphene-based nanoribbons with different densities and/or lengths determined by the user are applied on the fiber (2).

In an embodiment of the invention, the production system (1) comprises a deposition unit (4) having a chamber (8) which allows the chemical vapor deposition method to be applied on the fiber (2), and at least one condenser (9) located to almost completely surround the chamber (8), creating an electromagnetic field within the chamber (8), thus allowing deposition of the graphene and/or nanoribbons almost completely vertically on the fiber (2). Thanks to the electromagnetic field created by the condenser (9) located around the chamber (8), the conductive graphene and/or graphene-based nanoribbons are directed such that they are deposited vertically, instead of depositing at an angle, on the transition metals (FIG. 2).

In an embodiment of the invention, the production system (1) comprises a plurality of sensors (10) located in the chamber (8), which send laser beams on the fiber (2); a control unit (7) which enables real-time thickness measurement with the data received from the sensors (10), and ensures that the fiber (2) is transmitted to the iron coating unit (5) by means of the movement element (6) when the thickness value determined by the user is achieved. The control unit (7) evaluates the real-time thickness data depending on the graphene and/or graphene-based nanoribbon density and/or length values received from the sensors (10), and enables the system to automatically switch to the iron coating unit (5) when the thickness value determined by the user is achieved (FIG. 3).

In an embodiment of the invention, the production system (1) comprises a deposition unit (4) having a plurality of openings (11) which are provided on the chamber (8) so as to have almost exactly the same diameter as the fiber (2), and enable the fiber (2) to enter and exit the chamber (8) and to deposit the graphene and/or graphene-based nanoribbons almost completely homogenously on the fiber (2), and at least one sealing element (12) which prevents gaps between the fiber (2) and the openings (11). Thanks to the openings (11) that allow the fiber (2) to enter into the chamber (8), the fiber (2) is suspended in the chamber (8). Therefore, graphene and/or graphene-based nanoribbon is applied such that it almost completely surrounds the fiber (2) (FIG. 4).

In an embodiment of the invention, the production system (1) comprises a control unit (7) which enables the fiber (2) exiting the chamber (8) by means of the openings (11) to automatically re-enter the chamber (8) by means of the movement element (6) such that the fiber (2) surrounds the chamber (8) spirally, thus allowing the application of graphene and/or graphene-based nanoribbon on the fiber (2) simultaneously. Thanks to the movement elements (6) located around the chamber (8), the fiber (2) enters and exits into the chamber (8) through the openings (11). The simultaneous application of graphene and/or graphene-based nanoribbon on the longer fiber (2) without being limited by the size of the chamber (8) enables the process to proceed faster and saves time (FIG. 5).

In an embodiment of the invention, the production system (1) comprises at least one winding machine (13) which provides automatic knitting of the fiber (2) by means of the control unit (7); at least one fabric (14) which enables the radio waves to be routed since the graphene and/or graphene-based nanoribbons on the fiber (2) knitted by the winding machine (13) create a conductive network. The winding of the fiber (2) by the winding machine (13) after the iron coating unit (5) is automatically provided by the control unit (7). Graphene and/or graphene-based nanoribbons on the fiber (2) that move side by side on the winding machine (13) create a conductive network with each other. Thanks to the conductive network created, the radar absorbing material can be used for thermal management, lightning protection and electromagnetic shielding.

In an embodiment of the invention, the production system (1) comprises a control unit (7) which enables that the fiber (2) enters into the barrier coating unit (3) and coated with a solution (C) with a transition metal, the fiber (2) is moved by the movement element (6) so as to enter automatically into the deposition unit (4), the time during which the fiber (2) will remain in the deposition unit (4) is determined according to the temperature and/or pressure and/or time parameters determined by the user by the chemical vapor deposition method in the deposition unit (4), and graphene and/or graphene-based nanoribbons are bonded with transition metals, thereby adhering the graphene and/or graphene nanoribbons to the fiber (2), the fiber (2), on which graphene and/or graphene-based nanoribbon has been applied, enters automatically into the iron coating unit (5) by means of the movement element (6), the iron-based nanoparticles are applied on the fiber (2) in the iron coating unit (5), and the fiber (2) is automatically knitted by means of the winding machine (13). The fiber (2) is first treated in the barrier coating unit (3). It is applied by spraying the liquid solution (C), which is created by mixing the nano-sized transition metal on the fiber in the barrier coating unit (3), or by immersing the fiber (2) into the solution. Thanks to the solution (C) applied on the fiber (2), the fiber (2) strength is increased and wear is reduced. The fiber (2) coated with the solution (C) automatically passes to the deposition unit (4) by means of the control unit (7). In the deposition unit (4), graphene and/or graphene-based nanoribbon is applied on the fiber (2) by chemical vapor deposition method. The temperature, pressure and/or time parameters affecting the chemical vapor deposition process are input to the control unit by the user, so that graphene and/or graphene-based nanoribbons are applied on the fiber (2) at a density and/or length determined by the user. Graphene and/or graphene-based nanostrip applied fiber (2) automatically passes to the iron coating unit (5). The solution containing iron-based nanoparticle in the iron coating unit (5) is applied by spraying on the fiber (2) or by immersing the fiber into the solution. The fiber (2), which is treated in the barrier coating unit (3), the deposition unit (4) and the iron coating unit (5), respectively, automatically passes to the winding machine (13) so as to be knitted.

In an embodiment of the invention, the production system (1) comprises a first fabric (140) made of glass fiber (2), which almost completely reduces the reflection of radio waves since it is an insulating material. The first fabric (140) made of glass fiber (2) is an insulating material. Thanks to this feature, when exposed to radio waves, it reduces the reflection of radio waves and reduces the electrical conductivity in the direction of the radio waves.

In an embodiment of the invention, the production system (1) comprises a second fabric (141) made of carbon fiber (2), which converts radio waves into heat and/or electrical energy so that they are almost completely absorbed. The second fabric (141) made of carbon fiber (2) is conductive. Thanks to this feature, it absorbs radio waves and converts the energy formed into heat and/or electrical energy.

In an embodiment of the invention, the production system (1) comprises at least one radar absorbing structure (15) formed by laying a number of first fabrics (140) determined by the user on a number of second fabrics (141) determined by the user, such that density and/or length of the graphene and/or graphene-based nanoribbon gradually decreases. The fabrics (14) whose numbers have been determined by the user are laid manually. The laying of the fabrics (14) is carried out such that length and/or density of the graphene and/or graphene-based nanoribbon are reduced. When the radar absorbing structure (15) formed by the laying of fabrics (14) is applied on the airplane, the density and/or length of graphene and/or graphene-based nanoribbon gradually increases towards the inside of the fuselage. Therefore, primary wave and secondary wave are prevented from occurring on the fuselage. In order to absorb the primary wave, since the glass fiber (2) has graphene and/or graphene-based nanoribbons with less density and/or length, the impedance value of the glass fiber (2) is equal to (matches with) the impedance of the air, so that the primary wave is absorbed. The conductive network feature is preserved in the radar absorbing structure (15), which consists of fabrics (14) with conductive network.

In an embodiment of the invention, the production system (1) comprises a radar absorbing structure (15) which can be used in air and/or space and/or marine vehicles.

In an embodiment of the invention, the production system (1) comprises a sealing element in the form of an O-ring, a gasket and/or a paste. The sealing element (12) applied between the fiber (2) and the openings (11), which provide entrance and exit of the fiber (2) into/out of the chamber (8), prevents the formation of gaps and ensures that the chemical vapor deposition process is carried out in a closed chamber (8).

In an embodiment of the invention, the production system (1) comprises a movement element (6), which is a roller and/or a robotic arm. The transmission of the fiber (2) to the barrier coating unit (3), the deposition unit (4), the iron coating unit (5) and the winding machine (13), respectively, is provided precisely by rollers and/or a robotic arm.

1-13. (canceled)

14. A production system (1) for coating at least one fiber (2) for use in composite materials, comprising:
at least one barrier coating unit (3) comprising a solution (C) containing a transition metal; which barrier coating unit (3) is configured to surround the at least one fiber (2) with the solution (C) by using a dip and/or spray coating method, thereby protecting the fiber (2) surface from chemical and/or physical impacts;
at least one chemical vapor deposition unit (4) configured to deposit and bond graphene and/or graphene-based nanoribbons to said transition metal located at certain distances on the fiber (2), thus allowing the graphene and/or graphene-based nanoribbons to adhere to the fiber (2);
at least one iron coating unit (5) configured to apply iron-based nanoparticles onto the fiber (2) by dip and/or spray coating;
at least one movement element (6) which is configured to move the at least one fiber (2) along the direction it extends;
a control unit (7) configured to be move the fiber (2) automatically by the movement element (6), thereby sequentially treating the fiber (2) within the barrier coating unit (3), the deposition unit (4) and the iron coating unit (5); and
wherein the control unit (7) is configured to determine the time that the fiber (2) will remain in the deposition unit (4) according to the temperature and/or pressure and/or time parameters determined by the user, thereby depositing graphene and/or graphene-based nanoribbons of different densities and/or lengths on the fiber (2).

15. The production system (1) according to claim 14, wherein the deposition unit (4) has a chamber (8) for chemical vapor deposition and at least one condenser (9) to substantially surround the chamber (8), the condenser being configured to create an electromagnetic field within the chamber (8), thus allowing deposition of the graphene and/or nanoribbons almost completely vertically on the fiber (2).

16. The production system (1) according to claim 15, further comprising:
a plurality of sensors (10) located in the chamber (8) which send laser beams on the fiber (2); and
wherein the control unit (7) is configured to receive real-time thickness measurement with the data from the sensors (10), and transmit the fiber (2) to the iron coating unit (5) by means of the movement element (6) when the thickness value determined by the user is achieved.

17. The production system (1) according to claim 15, wherein the deposition unit (4) has a plurality of openings (11) which are provided on the chamber (8) so as to have almost exactly the same diameter as the fiber (2), and enable the fiber (2) to enter and exit the chamber (8) and to deposit the graphene and/or graphene-based nanoribbons almost completely homogenously on the fiber (2), and at least one sealing element (12) which prevents gaps between the fiber (2) and the openings (11).

18. The production system (1) according to claim 17, wherein the control unit (7) is configured to enable the fiber (2) exiting the chamber (8) through the openings (11) to automatically re-enter the chamber (8) by means of the movement element (6) such that the fiber (2) surrounds the chamber (8) spirally, thus allowing the application of graphene and/or graphene-based nanoribbon on the fiber (2) simultaneously.

19. The production system (1) according to claim 14, further comprising:
at least one winding machine (13) which provides automatic knitting of the fiber (2) by means of the control unit (7); and
at least one fabric (14) which enables the radio waves to be routed since the graphene and/or graphene-based nanoribbons on the fiber (2) knitted by the winding machine (13) create a conductive network.

20. The production system (1) according to claim 19, wherein the control unit (7) is configured to enable that:
the fiber (2) enters into the barrier coating unit (3) and is coated with a solution (C) with a transition metal,
the fiber (2) is moved by the movement element (6) so as to enter automatically into the deposition unit (4),
the time during which the fiber (2) will remain in the deposition unit (4) is determined according to the temperature and/or pressure and/or time parameters determined by the user by the chemical vapor deposition method in the deposition unit (4), and graphene and/or graphene-based nanoribbons are bonded with transition metals, thereby adhering the graphene and/or graphene nanoribbons to the fiber (2),
the fiber (2), on which graphene and/or graphene-based nanoribbon has been applied, enters automatically into the iron coating unit (5) by means of the movement element (6),
the iron-based nanoparticles are applied on the fiber (2) in the iron coating unit (5), and
the fiber (2) is automatically knitted by means of the winding machine (13).

21. The production system (1) according to claim 14, further comprising a first fabric (140) made of glass fiber (2), which substantially reduces the reflection of radio waves since it is an insulating material.

22. The production system (1) according to claim 14, further comprising a second fabric (141) made of carbon fiber (2), which converts radio waves into heat and/or electrical energy so that they are substantially absorbed.

23. The production system (1) according to claim 21, further comprising at least one radar absorbing structure (15) formed by laying a number of first fabrics (140) determined by the user on a number of second fabrics (141) determined by the user, such that density and/or length of the graphene and/or graphene-based nanoribbon gradually decreases.

24. The production system (1) according to claim 23, further comprising the radar absorbing structure (15) which can be used in air and/or space and/or marine vehicles.

25. The production system (1) according to claim 17, wherein the sealing element (12) has the form of an O-ring, a gasket and/or a paste.

26. The production system (1) according to claim 14, wherein the movement element (6) is a roller and/or a robotic arm.
